(19) United States
(12) Patent Application Publication
(10) Pub. No.: US 2009/0262453 A1
(43) Pub. Date: Oct. 22, 2009

(54) CARRIER TAPE HAVING LOCALIZED ADHESIVE IN CAVITY REGIONS

(75) Inventor: Douglas Wayne Romm, Sherman, TX (US)

Correspondence Address: TEXAS INSTRUMENTS INCORPORATED, P O BOX 655474, M/S 3999, DALLAS, TX, 75265, US

(73) Assignee: Texas Instruments, Inc.

(21) Appl. No.: 12/107,330

(22) Filed: Apr. 22, 2008

(51) Int. Cl. G11B 5/027

(52) U.S. Cl. 360/85

(57) ABSTRACT

A carrier tape (100) for releasably mounting electronic components (130) includes an upper surface (110), at least one region (120) for holding the electronic components extending down from the upper surface (110) having sidewall surfaces, and a bottom surface (140). A bottom surface adhesive layer (125) is positioned on at least a portion of the bottom surface (140). The upper surface (110) is exclusive of the bottom surface adhesive (125). The bottom surface adhesive can include a pressure sensitive adhesive (PSA).

### FIELD OF THE INVENTION

The present invention relates to carrier tape and tape and reel packing systems therefrom for releasably mounting electronic components.

### BACKGROUND

Semiconductor companies ship product in three basic configurations: stick magazine, tray, and tape and reel. Tape and reel is generally regarded as the most convenient configuration for high volume users, due to its compatibility with pick-and-place equipment for volume production.

The tape-and-reel configuration is generally used for transport and storage from the manufacturer or packaging facility of the electronic components to the customer, for use in the customer manufacturing plant. The electronic components can comprise bare die, packaged die, or other die assembly products. This configuration is designed for feeding electronic components to automatic-placement machines for surface mounting on board assemblies. The configuration can generally be used for all surface mount (SMT) packages and provides component lead isolation during shipping, handling, and processing. The configuration comprises of a carrier tape with sequential individual cavities (e.g. embossed pockets) that hold individual electronic components, and a cover tape that seals the carrier tape to retain the components in the cavities.

The reel is generally constructed of anti-static material that provides electrostatic discharge (ESD) protection. The carrier tape is generally made of an electrically conductive polystyrene material, or equivalent to protect devices from ESD damage. The surface resistivity of the conductive polystyrene is generally less than 1.0×10⁶ ohms per square inch. The cover tape characteristics generally include anti-static, transparency, and heat-activated adhesive coating.

Tape technology has been used for packing chip scale packages (CSPs). According to IPC's standard J-STD-012, “Implementation of Flip Chip and Chip Scale Technology”, to qualify as being “chip scale”, the package must have an area no greater than 1.2 times that of the die that is being packaged and it has to be a single-die, direct surface mountable package. Another criterion that is often applied to qualify these packages as CSPs is that their ball pitch should be no more than 1 mm. With larger packages the size and weight of the package is generally sufficient to hold the package in place inside the pocket. However, in the case of smaller sized CSPs, it becomes difficult to design a standard carrier tape solution that will function without problems.

### SUMMARY

This Summary is provided to comply with 37 C.F.R. § 1.73, requiring a summary of the invention briefly indicating the nature and substance of the invention. It is submitted with the understanding that it will not be used to interpret or limit the scope or meaning of the claims.

With the significantly smaller size and weight of packages including certain CSPs as compared to other packages and package types, rather than weight, the forces of surface tension and adhesion become the more significant retaining factors. For small packages such as small CSPs, the Present Inventor has found these forces together with gravity are not generally enough to hold the package in place inside the pocket (or channel). For example, because CSPs can be very small and lightweight they can be “tossed” from the carrier tape pocket as the cover tape is removed at the customer facility. In other cases when the pocket size is not close to that of the die or package, the CSP can turn on edge or even turn completely over inside the embossed pocket. In response to these problems, embodiments of the present invention provide a new tape technology that substantially overcomes the above described deficiencies which can be problematic particularly for smaller packages, such as certain CSPs.

Embodiments of the invention describe a carrier tape for releasably mounting a plurality of electronic components comprises an upper surface and at least one region for holding electronic components. The region for holding extends down from the upper surface and has sidewall surfaces and a bottom surface. An adhesive layer on the bottom surface referred to herein as the “bottom surface adhesive” is positioned on at least a portion of the area of the bottom surface. The upper surface is exclusive of the bottom surface adhesive. The bottom surface adhesive can comprise a pressure sensitive adhesive (PSA).

Another embodiment of the invention comprise a carrier tape for releasably mounting electronic components comprising an upper surface, at least one region for holding the electronic components extending down from the upper surface having sidewall surfaces and a bottom surface, and a bottom surface adhesive positioned on at least a portion of the bottom surface. The upper surface is exclusive of the bottom surface adhesive. In this embodiment, the bottom surface adhesive can comprise a pressure sensitive adhesive (PSA).

### DESCRIPTION OF THE DRAWINGS

FIGS. 1A and B show a top view and a cross section view, respectively, of carrier tape having pocket regions according to an embodiment of the invention.

FIGS. 2A and B show a top view, and a side cross section view, respectively, of carrier tape having a channel according to another embodiment of the invention

FIG. 3 shows a depiction of a tape and reel packing system for transporting electronic components according to yet an embodiment of the invention.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

A carrier tape for releasably mounting a plurality of electronic components comprises an upper surface and at least one region for holding electronic components. The region for holding extends down from the upper surface and has sidewall surfaces and a bottom surface. An adhesive on the bottom surface referred to herein as the “bottom surface adhesive” is positioned on at least a portion of the area of the bottom surface. In one embodiment, the entire bottom surface is covered with bottom surface adhesive.

The upper surface is exclusive of the bottom surface adhesive. The bottom surface adhesive can comprise a pressure sensitive adhesive (PSA). After the electronic components are placed in the pocket or channel they are generally maintained in their respective positions until they arrive at the customer's location, such as for a pick-and-place assembly operation.

The present Inventor has found that it is advantageous to confine the adhesive to the bottom of the pocket or channel areas according to embodiments of the invention because excess adhesive can interfere with release of the cover tape from the carrier tape during customer use. Moreover, the carrier tape is generally wound onto a spool or reel from the tape manufacturer for delivery to the IC manufacturer. Adhesive applied on the top portion of the carrier tape can cause the carrier tape to stick to itself when wound during packing.

Significantly, embodiments of the invention can use the same dimensions as existing pocket tape, even if pocket is comparatively large (e.g. ≧150%) as compared to area of the electronic component, such as a packaged electronic component (e.g. CSP). Embodiments of the invention are generally thus not disruptive to customers because embodiments of the invention can fit current form factors, such as for conventional polystyrene embossed pocket carrier tape. As a result, customers do not generally need to modify their equipment to process tapes according to embodiments of the invention.

The bottom surface adhesive can be locally applied to the bottom of the pocket or channel. There are various methods for locally applying adhesive to the bottom of the pocket or channel. Exemplary methods include, but are not limited to, using a masking or spray method.

The electronic components are then placed in the pockets or channels generally by a pick and place method. A cover tape is then used to cover the pocket or channel, such as in an analogous manner to known embossed pocket tape application.

As known in the art of adhesives, a pressure sensitive adhesive (PSA, self adhesive, self stick adhesive) is an adhesive that forms a bond when pressure is applied to marry the adhesive with the adhered. No solvent, water, or added heat is generally needed to activate the adhesive. Pressure sensitive indicates the degree of bond is influenced by the amount of pressure which is used to apply the adhesive to the surface.

A variety of generally polymeric materials can be used as the PSA. One embodiment is an acrylic pressure-sensitive adhesive that can be prepared by solution-polymerizing monomers mainly comprising a (meth)acrylic acid alkyl ester. Other possible adhesive polymers can be block copolymers, natural rubbers, acrylic adhesives, silicones and the like. Block copolymer adhesives include ethylene-propylene adhesives, styrene-ethylene butylenes-styrene adhesives, and the like. Such adhesives are generally commercially available, such as from Shell Chemical or the Exxon Chemical Company. The pressure-sensitive adhesive may further contain tackifiers, antifoaming agents, antioxidants, and the like to the extent that it does not interfere with the adhesive properties.

Certain PSAs are disclosed in U.S. Pat. No. 3,691,140 to Silver, assigned to 3M. These and related PSAs are used for POST-IT® notes. Silver discloses inherently tacky, elastomeric, polymers which are uniformly solvent-insoluble, solvent-dispersible, of small size, and suited for use in aerosol spray adhesives. The polymers easily disperse in various solvents to provide non-plugging suspensions which spray without cobwebbing. The polymers are disclosed to permit bonding of paper or other materials to various substrates, permit easy removal of bonded paper from the substrate without tearing, and also permit subsequent rebonding of the paper without application of additional adhesive.

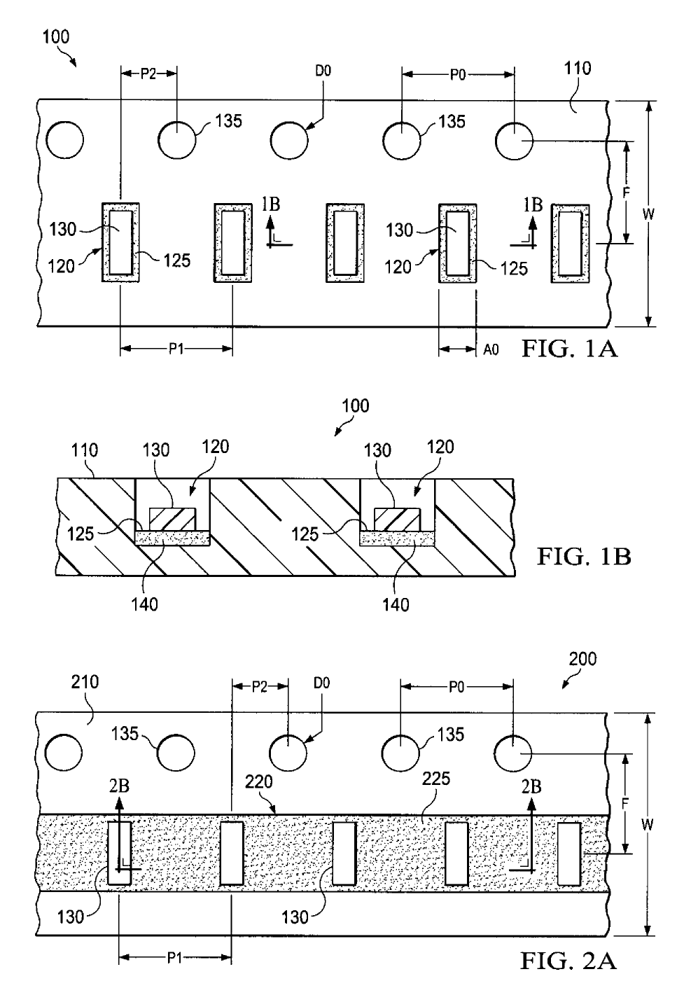

FIGS. 1A and B show a top view and a cross section view, respectively, of carrier tape 100 according to an embodiment of the invention. Carrier tape 100 comprises an upper surface 110, and a plurality of pocket regions 120 for holding electronic components extending down from the upper surface 110 having sidewall surfaces and a bottom surface 140. The carrier tape can comprise a variety of known materials such as polycarbonate, polystyrene, and trilaminate polycarbonate with an acrylonitrile butadiene styrene (ABS) core.

The pocket regions 120 are typically vacant hexahedron regions which have four enclosed sides. Although shown as being rectangular, by way of example, the geometry of the pocket region 120 may assume any convenient shape suitable for component retention, including round or oval.

A bottom surface adhesive 125 is positioned on at least a portion of the area of the bottom surface of the indented pockets 120. The height/thickness of bottom surface adhesive 125 is generally from 2 to 20% of the height of the pocket region 120. An electronic circuit (e.g. packaged IC, such as a CSP) 130 is disposed on the bottom surface adhesive 125. The upper surface 110 is exclusive of the bottom surface adhesive 125. The bottom surface adhesive 125 can comprise a pressure sensitive adhesive (PSA) or other adhesive that provides an adhesion force that is comparable to the adhesion force of a PSA (and thus significantly less as compared to heat activated adhesives).

Carrier tape 100 includes a plurality of sprocket drive holes 135 which are operable to engage gear teeth of a drive wheel or similar engaging mechanism and translate carrier tape 100 in synchronization with a drive of an automated assembly machine.

Regarding the dimensions shown in FIG. 1A:

A0=Dimension designed to accommodate the width of component 130.

B0=Dimension designed to accommodate the length of component 130.

W=Overall width of the carrier tape 100.

P1=Pitch between successive centers of pockets 120.

F=Distance from the center of the sprocket hole 135 to the center of the pocket 120, in the same direction as the width (W) of the tape 100.

P0=Distance between sprocket holes 135.

P2=Distance from the center of the sprocket hole 135 to the center of the pocket 120, in the lateral direction of the tape 100.

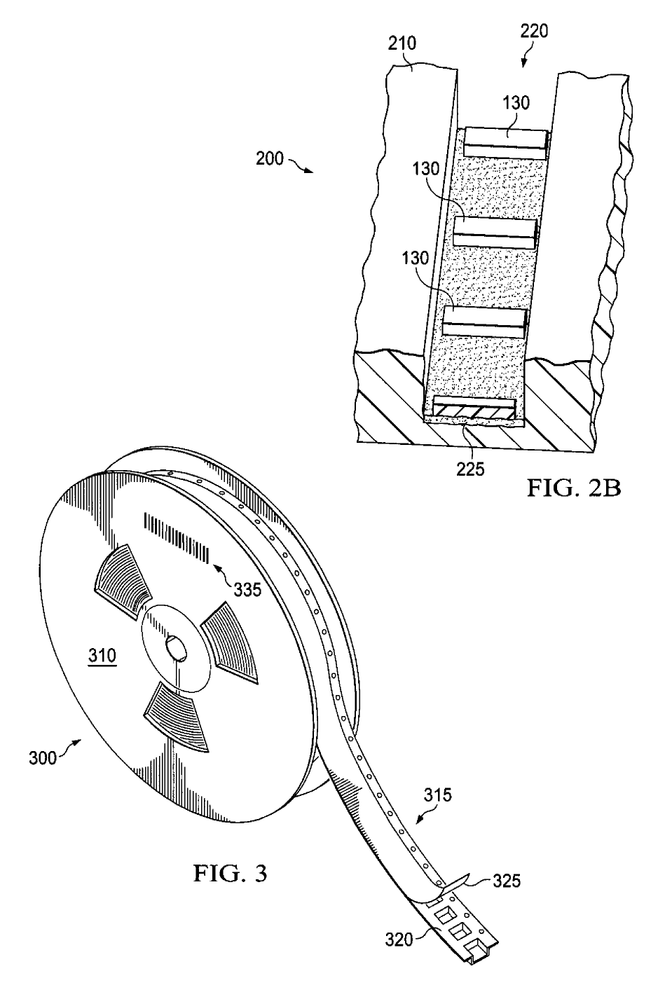

FIGS. 2A and B show a top view, and a side cross section view, respectively, of carrier tape 200 according to an embodiment of the invention comprising a channel 220 which runs along the length of the tape. Although only one channel 220 is shown in FIGS. 2A and B, more than one channel running in parallel along the length of the tape is also possible. Carrier tape 200 comprises an upper surface 210, and a channel region 220 for holding electronic components (e.g. CSPs) extending down from the upper surface 210 having sidewall surfaces and a bottom surface. Bottom surface adhesive 225 is on the bottom surface of the channel 220. As with carrier tape 100, the height/thickness of bottom surface adhesive 225 is generally from 2 to 20% of the height of the channel 220. An electronic circuit (e.g. packaged IC) 130 is disposed on the bottom surface adhesive 225. The upper surface 210 is exclusive of the bottom surface adhesive 225. As with carrier tape 100, carrier tape 200 can comprise a pressure sensitive adhesive (PSA) or other adhesive having a similar low adhesion strength to permit easy removal of the electronic circuit, with little or no measurable adhesive accompanying the electronic circuit upon removal.

FIG. 3 shows a depiction of a tape and reel packing system 300 for transporting electronic components. System 300 comprises a source tape reel 310 operable to hold a length of a tape 315. The tape 315 comprises a carrier tape 320 and a cover tape 325 on the carrier tape 320. Tape generally comprises several hundred electronic components (not shown). Carrier tape 320 shown is the pocket embodiment analogous to carrier tape 100 shown in FIG. 1A. However, carrier tape 320 can also comprise the channel embodiment corresponding to carrier tape 200. In either arrangement, the bottom surface includes a bottom surface adhesive positioned on at least a portion of the bottom surface. The upper surface of the carrier tape 320 is exclusive of the bottom surface adhesive. Reel includes a bar code label 335 to identify its contents.

### EXAMPLE

The Example provided below is a non-limiting example and in no way reflects any limitation on the scope of embodiments of the present invention.

POST-IT® notes having a low adhesion PSA surface on a portion thereof as described above were used to initially evaluate operability of embodiments of the invention. IC bumped dies were placed on the PSA part of the POST-IT® note and the POST-ITS note was manually turned over. Despite the tacky PSA area on the POST-IT® having a very low adhesion, such as compared to a heat sensitive adhesive, the adhesive force was sufficient to hold all the dies in place when the POST-ITT was turned upside down. Upon removal and visual inspection of the dies, no PSA was seen on any of the dies.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and/or the claims, such terms are intended to be inclusive in a manner similar to the term “comprising.”

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the following claims.

1. A carrier tape for releasably mounting electronic components, comprising: an upper surface;
at least one region for holding said electronic components extending down from said upper surface having sidewall surfaces and a bottom surface, and
a bottom surface adhesive positioned on at least a portion of said bottom surface, said upper surface being exclusive of said bottom surface adhesive.

2. The carrier tape of claim 1, wherein said bottom surface adhesive comprises a pressure sensitive adhesive (PSA).

3. The carrier tape of claim 1, wherein said carrier tape comprises a material selected from the group consisting of polycarbonate, polystyrene, trilaminate polycarbonate with an acrylonitrile butadiene styrene (ABS) core and a homogeneous blend of two or more plastics.

4. The carrier tape of claim 1, wherein said at least one region comprises a plurality of indented pockets for accommodating said electronic components formed intermittently in a lengthwise direction of said carrier tape.

5. The carrier tape of claim 1, wherein said at least one region comprises a channel which runs a length of said carrier tape.

6. The carrier tape of claim 1, further comprising a plurality of sprocket drive holes operable to engage gear teeth of a drive wheel or similar engaging mechanism and translate said carrier tape in synchronization with a drive of an automated assembly machine.

7. A tape and reel packing system for transporting electronic components, comprising:
a source tape reel operable to hold a length of a tape;
said tape comprising a carrier tape and a cover tape on said carrier tape,
said carrier tape comprising:
an upper surface;
at least one region for holding said electronic components extending down from said upper surface having sidewall surfaces and a bottom surface, and
a bottom surface adhesive positioned on at least a portion of said bottom surface, said upper surface being exclusive of said bottom surface adhesive.

8. The system of claim 7, wherein said electronic components comprise chip scale packages.

9. The system of claim 7, wherein said bottom surface adhesive comprises a pressure sensitive adhesive (PSA).

10. The system of claim 7, wherein said at least one region comprises a plurality of indented pockets for accommodating said electronic components formed intermittently in a lengthwise direction of said carrier tape.

11. The system of 7, wherein said at least one region comprises a channel which runs a length of said carrier tape.

12. The system of claim 7, wherein said tape further comprises a plurality of sprocket drive holes operable to engage gear teeth of a drive wheel or similar engaging mechanism and translate said carrier tape in synchronization with a drive of an automated assembly machine.

13. A carrier tape for releasably mounting electronic components, comprising: an upper surface;
at least one region for holding said electronic components extending down from said upper surface having sidewall surfaces and a bottom surface, and
a bottom surface adhesive positioned on at least a portion of said bottom surface, said upper surface being exclusive of said bottom surface adhesive, wherein said bottom surface adhesive comprises a pressure sensitive adhesive (PSA).

14. The carrier tape of claim 13, wherein said at least one region comprises a plurality of indented pockets for accommodating said electronic components formed intermittently in a lengthwise direction of said carrier tape.

15. The carrier tape of claim 13, wherein said at least one region comprises a channel which runs a length of said carrier tape.

16. A transportable electronic arrangement, comprising:
a plurality of electronic components, and a carrier tape, said carrier tape comprising:
an upper surface;
at least one region for holding said plurality of electronic components extending down from said upper surface having sidewall surfaces and a bottom surface, and a bottom surface adhesive positioned on at least a portion of said bottom surface, said upper surface being exclusive of said bottom surface adhesive.

17. The electronic arrangement of claim 16, wherein said bottom surface adhesive comprises a pressure sensitive adhesive (PSA).

18. The electronic arrangement of claim 16, wherein said at least one region comprises a plurality of indented pockets for accommodating said electronic components formed intermittently in a lengthwise direction of said carrier tape.

19. The electronic arrangement of claim 16, wherein said at least one region comprises a channel which runs a length of said carrier tape.

20. The electronic arrangement of claim 16, further comprising a plurality of sprocket drive holes operable to engage gear teeth of a drive wheel or similar engaging mechanism and translate said carrier tape in synchronization with a drive of an automated assembly machine.

21. The electronic arrangement of claim 16, wherein said plurality of electronic components comprises a plurality of bare die.

22. The electronic arrangement of claim 16, wherein said plurality of electronic components comprises a plurality of packaged integrated circuits.
